(19) United States
(12) Patent Application Publication
(10) Pub. No.: US 2015/0065221 A1
(43) Pub. Date: Mar. 5, 2015

(54) METHOD AND DEVICE FOR OPERATING 3D VIRTUAL CHESSBOARD

(71) Applicant: SAMSUNG ELECTRONICS CO., LTD., SUWON-SI (KR)

(72) Inventor: Qian LIPING, Hangzhou (CN)

(21) Appl. No.: 14/016,674

(22) Filed: Sep. 3, 2013

(51) Int. Cl. A63F 13/53; G06F 3/01; G03H 1/00; A63F 13/42; G03H 1/22

(52) U.S. Cl. CPC A63F 13/53; A63F 13/42; G03H 1/22; G03H 1/0005; G06F 3/017
USPC 463/14

(57) ABSTRACT

A device for operating 3D virtual chessboard includes: an image identifier identifying images captured by the at least two cameras; a start action determiner determining start of chess games based on the image identification result of the image identifier to determine which chess piece is moved; an end action determiner determining end of chess games based on the image identification result of the image identifier to determine the final location to which the chess piece is moved; an effective location determiner determining whether the final location of the moved chess piece is a valid location based on chess rules; a mapper mapping the final location into a coordinate location of the chess piece, if the effective location determiner determines that the final location to which the chess piece is moved is valid; and a chessboard updater updating the chessboard displayed based on the coordinate location of the chess piece.

### BACKGROUND OF THE INVENTION

1. Field of the Invention

The present invention relates to application of a tablet PC, in particular, the present invention relates to a method and device for operating three dimensions (3D) virtual chessboard by using a tablet PC and projection technology.

2. Background of the Invention

Currently, applications for a tablet PC are increasing. However, there is few or no an application for combining a tablet PC and projection technology is little, in particular, no method for combining a tablet PC and projection technology to conduct 3D virtual chessboard occurs.

### SUMMARY OF THE INVENTION

According to an aspect of the present invention, a device for operating 3D virtual chessboard is provided, the device is used for a tablet PC provided with at least two cameras and one micro 3D holograph projector, the at least two cameras are used to capture images of chess games, and the micro 3D holograph projector is used to map the chessboard displayed on the tablet PC into 3D space, wherein the device includes: an image identifying module which identifies images captured by the at least two cameras; a start action determining module which determines the start of an action for chess games based on the image identification result of the image identifying module, so as to determine which chess piece is moved; an end action determining module which determines the end of the action for chess games based on the image identification result of the image identifying module, so as to determine the final location to which the chess piece is moved; an effective location determining module which determines whether the final location to which the chess piece is moved is an effective location based on a rule of chess games; a mapping module which maps the final location into a coordinate location of the chess piece on the tablet PC, if the effective location determining module determines that the final location to which the chess piece is moved is the effective location; a chessboard updating module which updates the chessboard displayed on the tablet PC based on the coordinate location of the chess piece on the tablet PC.

The start action determining module counts the gestures identified by the image identifying module, and determines the start of the action of chess games, so as to determine which one chess piece is moved, if the counting number of the gestures identified in a predetermined time period is larger than or equal to a predetermined threshold.

If no gesture in images captured by the at least two cameras is identified by the image identifying module in a predetermined time period, the end action determining module determines the end of the current action for chess games, so as to determine the final location to which the chess piece is moved.

The mapping module maps the final location into a coordinate location of the chess piece on the tablet PC, based on the distance h between the projected image by projecting of the projector and the tablet PC and the scaling factor α between the projected image and the image displayed on the tablet PC.

The mapping module maps the final location into a coordinate location of the chess piece on the tablet PC, according to the following mapping relationship between the coordinate (x′, y′, z′) of the projected image in 3D space and the coordinate (x, y) of the image displayed on the tablet PC: x′=αx, y′=αy, z′=h.

Wherein, h and α are constants, which are obtained upon initializing the 3D virtual chessboard after setting the projector.

According to another aspect of the present invention, a method for operating 3D virtual chessboard is provided, the method is applied to a tablet PC provided with at least two cameras and one micro 3D holograph projector, the at least two cameras are used to capture images of chess games, and the micro 3D holograph projector is used to map the chessboard displayed on the tablet PC into 3D space, wherein the method includes the following steps: identifying images captured by the at least two cameras; determining the start of an action for chess games based on the image identification result, so as to determine which chess piece is moved; determining the end of the action for chess games based on the image identification result, so as to determine the final location to which the chess piece is moved; determining the final location to which the chess piece is moved is an effective location based on the rule of chess games; mapping the final location into a coordinate location of the chess piece on the tablet PC, if it is determined that the final location to which the chess piece is moved is the effective location; updating the chessboard displayed on the tablet PC based on the coordinate location of the chess piece on the tablet PC.

The step of determining the start of an action for chess games based on the image identification result, so as to determine which chess piece is moved, includes: counting the gestures identified by the image identification, and determining the start of the action of chess games, so as to determine which one chess piece is moved, if the counting number of the gestures identified in a predetermined time period is larger than or equal to a predetermined threshold.

The step of determining the end of the action for chess games based on the image identification result, so as to determine the final location to which the chess piece is moved, includes: if no gesture in images captured by the at least two cameras is identified in a predetermined time period, determining the end of the current action for chess games, so as to determine the final location to which the chess piece is moved.

The step of mapping the final location into a coordinate location of the chess piece on the tablet PC includes: mapping the final location into a coordinate location of the chess piece on the tablet PC, based on the distance h between the projected image by projecting of the projector and the tablet PC and the scaling factor α between the projected image and the image displayed on the tablet PC.

Mapping the final location into a coordinate location of the chess piece on the tablet PC, according to the following mapping relationship between the coordinate (x′, y′, z′) of the projected image in 3D space and the coordinate (x, y) of the image displayed on the tablet PC: x′=αx, y′=αy, z′=h.

Wherein, h and α are constants, which can be obtained upon initializing the 3D virtual chessboard after setting the projector.

According to an exemplary embodiment of the present invention, a device and method for operating 3D virtual chessboard is proposed in conjunction with the tablet PC and projection technology, so that a user is convenient for operation greatly, the user is provided with an interactive manner for funny, and interactive effects between the user and machine are enhanced.

### BRIEF DESCRIPTION OF THE DRAWINGS

The above and other objects, features and virtues of the present invention will become more apparent by describing in detail exemplary embodiments thereof in conjunction with the drawings, in which:

FIG. 1 is a diagram illustrating a relationship between a coordinate system in which an image displayed on the tablet PC is located and a coordinate system in which 3D space image obtained by projecting the image through the micro 3D holograph projector;

FIGS. 2-5 are diagrams illustrating coordinate information corresponding to each camera among the four cameras C1 through C4 provided in the tablet PC;

FIG. 6 is a block diagram for illustrating the device for operating 3D virtual chessboard according to exemplary embodiments of the present invention;

FIG. 7 is a flowchart illustrating a method for operating 3D virtual chessboard according to exemplary embodiments of the present invention;

FIG. 8 is a diagram illustrating a scene using the device and method for operating 3D virtual chessboard according to exemplary embodiments of the present invention.

### DETAILED DESCRIPTION OF EXEMPLARY EMBODIMENTS

Now exemplary embodiments of the present invention will be more fully described with reference to the accompanying drawings.

In order to apply a tablet PC and projection technology to 3D virtual chessboard, at least two cameras and a micro 3D holograph projector (hereinafter, referred to as projector for short) are provided in the tablet PC.

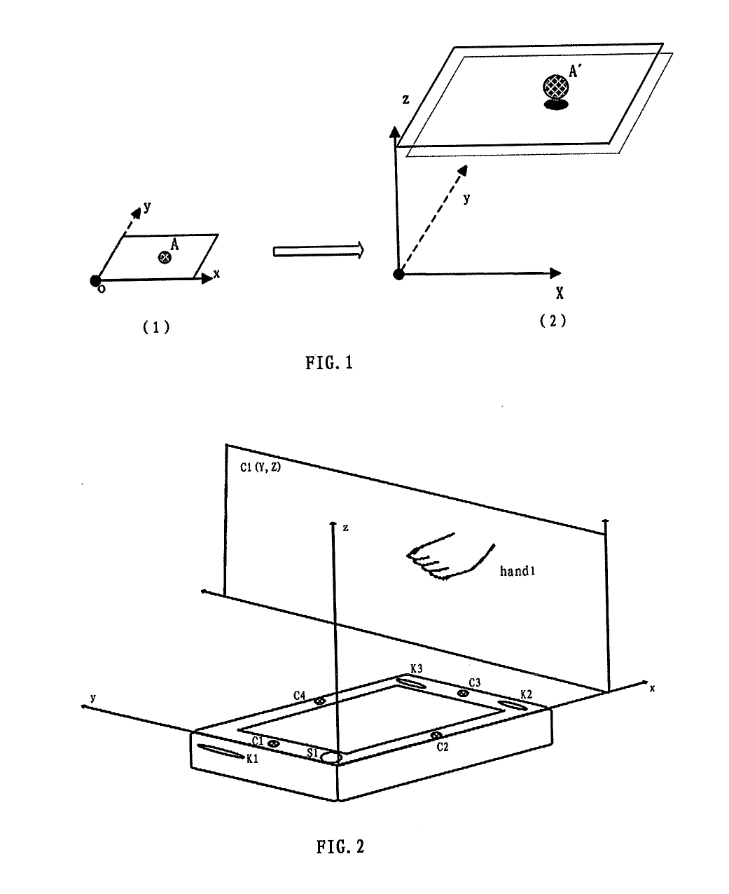

First, a relationship between a coordinate system in which an image displayed in the tablet PC is located and a coordinate system in which projected image in 3D space obtained by projecting the image through the micro 3D holograph projector will be described by referring to FIG. 1.

FIG. 1 is a diagram illustrating a relationship between a coordinate system in which an image displayed in the tablet PC is located and a coordinate system in which 3D space image obtained by projecting the image through the micro 3D holograph projector.

As illustrated in FIG. 1, the coordinate of the A point of the tablet PC in the two dimensions (2D) system is illustrated as A(x, y), and the coordinate of the A′ point of the projected image formed by scaling and projecting in 3D space an image in the two dimensions (2D) system is illustrated as A′(x′, y′, z′). Assuming that contents displayed by the tablet PC are projected vertically, if a distance between the projected image by projecting of the projector and the tablet PC is h, a scaling factor between the projected image and the image displayed on the tablet PC is α, then the relationship between the coordinate of the A point and coordinate of the A′ point can be expressed as: x′=αx, y′=αy, z′=h, wherein with respect to a specific projection, both h and α are constants, which can be obtained upon initializing the 3D virtual chessboard after setting the projector. Accordingly, since the distance h between the projected image by projecting of the projector and the tablet PC is a constant, coordinate information of a gesture or a chess piece can be obtained only by capturing images only by two cameras, one of which can be used to obtain coordinate information of a location of the gesture or the chess piece in x-axis, and another of which can be used to obtain coordinate information of a location of the gesture or the chess piece in y-axis. Then location corresponding to the chess piece on the tablet PC can be obtained by using the correspondence relationship described above between the projected image and the image displayed on the tablet PC and coordinate information of the location in which the projected gesture or chess piece is located in 3D space.

Hereinafter the coordinate information of the images captured by cameras, for example four cameras, at each location is described by referring to FIGS. 2-5.

FIGS. 2-5 illustrate coordinate information corresponding to each camera among the four cameras C1 through C4 provided in the tablet PC.

By referring to FIG. 2, coordinate information of hand 1 in y-axis and z-axis in space, that is, location information in y-axis direction and in z-axis direction can be obtained by the camera C1.

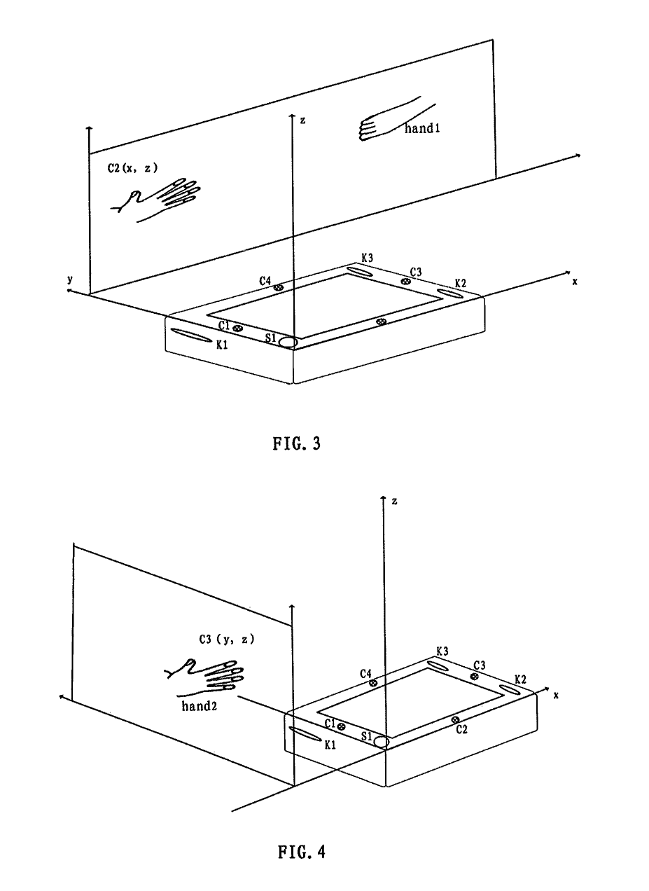

By referring to FIG. 3, coordinate information of hand 1 and hand 2 in x-axis and z-axis in space, that is, location information in x-axis direction and in z-axis direction can be obtained by the camera C2.

By referring to FIG. 4, coordinate information of hand 2 in y-axis and z-axis in space, that is, location information in y-axis direction and in z-axis direction can be obtained by the camera C3.

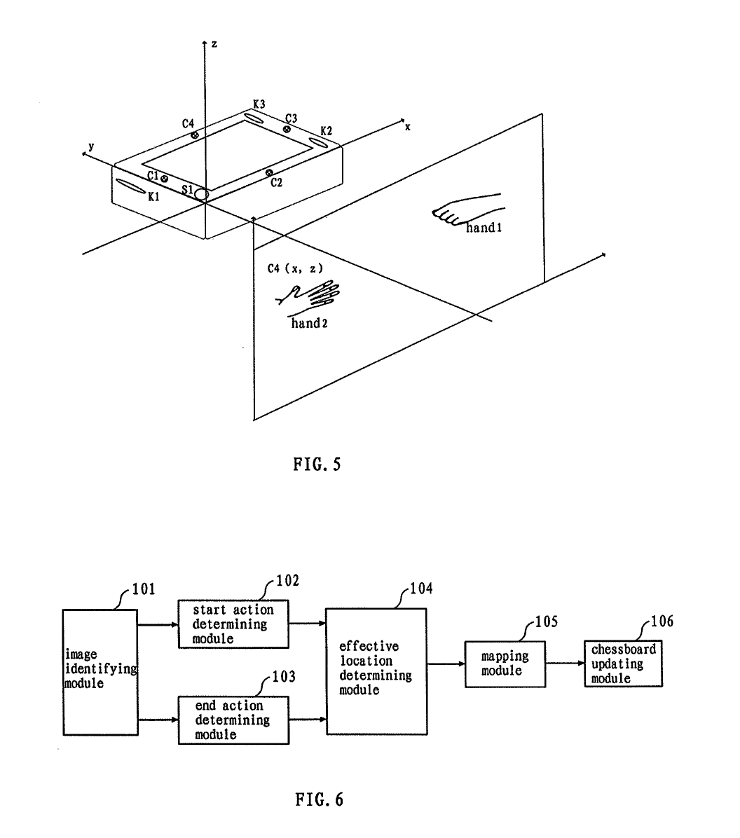

By referring to FIG. 5, coordinate information of hands 1 and 2 in x-axis and z-axis in space, that is, location information in x-axis direction and in z-axis direction can be obtained by the camera C4.

That is, the location information of hand 1 in y-axis and in z-axis in space can be obtained by the camera C1, and the location information of hand 1 in x-axis and in z-axis in space can be obtained by the camera C2 or C4, then the location information of hand 1 of a chess player in the direction of C3 in the 3D coordinate system (x, y, z) by combining the cameras C1 and C2 or by combining cameras C1 and C4.

The location information of hand 2 in y-axis and in z-axis in space can be obtained by the camera C3, and the location information of hand 2 in x-axis and in z-axis in space can be obtained by the camera C2 or C4, then the location information of hand 2 of the chess player in the direction of C1 in the 3D coordinate system (x, y, z) by combining the cameras C3 and C2 or by combining the cameras C3 and C4.

Similarly, coordinate information of an object in 3D space at other directions of the tablet PC by combining the coordinate information in the 2D coordinate system of two cameras. In fact, panorama image of a scene in range of 360 degrees can be captured by operating 4 cameras at the same time, and a holographic image can be obtained by reconstructing the images of four directions for 3D image.

A method and device for operating 3D virtual chessboard according to exemplary embodiments of the present invention will be described in detail in conjunction with at least two cameras and one projector provided installed in the tablet PC.

FIG. 6 is a block diagram for illustrating the device for operating 3D virtual chessboard according to exemplary embodiments of the present invention, wherein the device is used for a tablet PC provided with at least two cameras and one micro 3D holograph projector, the at least two cameras are used to capture images of chess games, and the micro 3D holograph projector is used to map the chessboard displayed on the tablet PC into 3D space.

By referring to FIG. 6, the device 100 for operating 3D virtual chessboard according to exemplary embodiments of the present invention includes an image identifying module 101, a start action determining module 102, an end action determining module 103, an effective location determining module 104, a mapping module 105 and a chessboard updating module 106.

The image identifying module 101 identifies images captured by the at least two cameras.

The start action determining module 102 determines the start of an action for chess games based on the image identification result of the image identifying module 101, so as to determine which chess piece is moved.

The end action determining module 103 determines the end of the action for chess games based on the image identification result of the image identifying module 101, so as to determine the final location to which the chess piece is moved.

The effective location determining module 104 determines the final location to which the chess piece is moved is an effective location based on the rule of chess games.

The mapping module 105 maps the final location into a coordinate location of the chess piece on the tablet PC, if the effective location determining module 104 determines that the final location to which the chess piece is moved is the effective location.

The chessboard updating module 106 updates the chessboard displayed on the tablet PC based on the coordinate location of the chess piece on the tablet PC.

Hereinafter operations of the above respective module will be described in detail.

The image identifying module 101 identifies images captured by the at least two cameras, so as to determine whether a gesture exists. If the image identifying module 101 identifies that there is a gesture in the image, the start action determining module 102 determines whether the gesture is a start action for chess games. In particular, the start action determining module 102 counts the gestures identified by the image identifying module 101. If the counting number of the gestures identified in a predetermined time period is larger than or equal to a predetermined threshold (for example, a number of 5), the start action determining module 102 determines that the action is the start action for chess games, that is, determines the start of the action of chess games, so as to determine which one chess piece is moved.

Then, if no gesture in images captured by four cameras is identified by the image identifying module 101 in a predetermined time period, the end action determining module 103 determines the end of the current action for chess games, so as to determine the final location to which the chess piece is moved (in order to describe conveniently, the final location to which the chess piece is moved is referred to as the final location).

The effective location determining module 104 determines whether the location, to which the chess piece is moved, is an effective location, based on which one chess piece is moved and the final location to which the chess piece is moved, according to the rule of chess games.

If the effective location determining module 104 determines that the location, to which the chess piece is moved, is an effective location, the mapping module 105 can map the final location into a coordinate location of the chess piece on the tablet PC.

In particular, the mapping module 105 can map the final location into a coordinate location of the chess piece on the tablet PC, based on the distance h between the projected image by projecting of the projector and the tablet PC and the scaling factor α between the projected image and the image displayed on the tablet PC.

If the effective location determining module 104 determines that the location, to which the chess piece is moved, is not the effective location, the operation for the current chess games is terminated.

The mapping module 105 can map the final location into a coordinate location of the chess piece on the tablet PC, according to the following mapping relationship between the coordinate (x′, y′, z′) of the projected image in 3D space and the coordinate (x, y) of the image displayed on the tablet PC: x′=αx, y′=αy, z′=h.

For example, the final location of the moved chess piece in 3D space is known, that is, the coordinate (x′, y′, z′) corresponding to the final location of the moved chess piece in 3D space is known, by using the mapping relationship between the coordinate of the projected image in 3D space and the coordinate of the image displayed on the tablet PC: x′=αx, y′=αy, the location in the tablet PC, to which the moved chess piece is finally moved, can be obtained (that is, the location of the chess piece in the tablet PC after updating).

The chessboard updating module 106 updates the chessboard based on the corresponding location of the chess piece on the tablet PC.

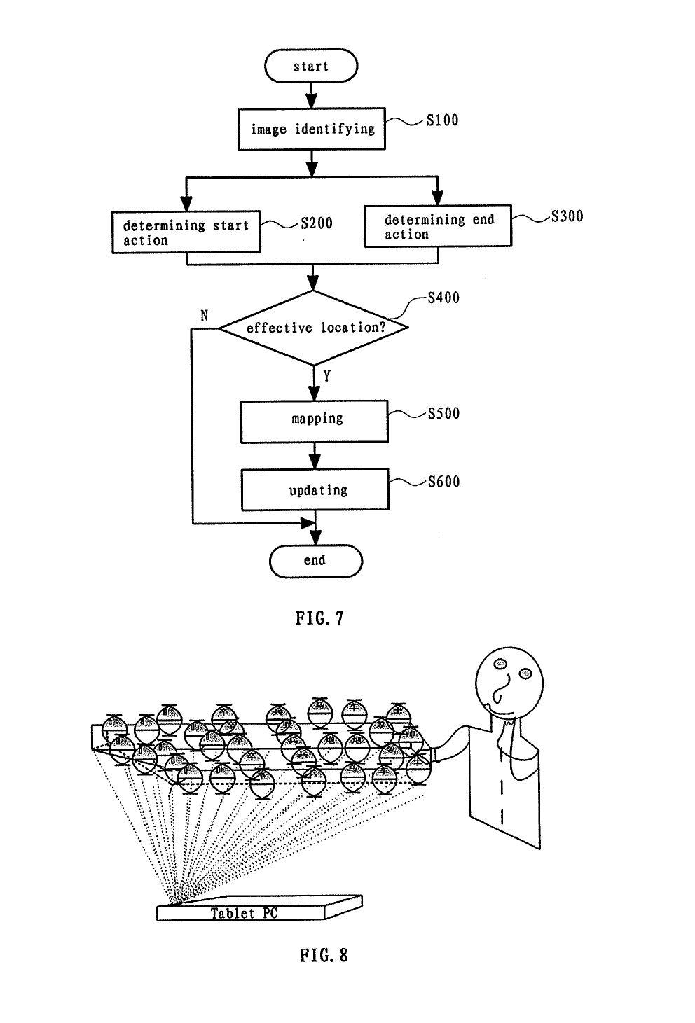

FIG. 7 is a flowchart illustrating a method for operating 3D virtual chessboard according to exemplary embodiments of the present invention, wherein the method is applied to a tablet PC provided with at least two cameras and one micro 3D holograph projector, the at least two cameras are used to capture images of chess games, and the micro 3D holograph projector is used to project the chessboard displayed on the tablet PC to 3D space.

By referring to FIG. 7, in operation. S100, images captured by the at least two cameras are identified.

In operation S200, the start of an action for chess games is determined based on the image identification result, so as to determine which chess piece is moved. In particular, the gestures identified by the image identifying module 101 are counted. If the counting number of the gestures identified in a predetermined time period is larger than or equal to a predetermined threshold, it is determined that the action is the start action for chess games, so as to determine which one chess piece is moved.

In operation S300, the end of the action for chess games is determined based on the image identification result, so as to determine the final location to which the chess piece is moved. In particular, if no gesture in images captured by the at least two cameras is identified in a predetermined time period, the end action determining module determines the current action for chess games ends, so as to determine the final location to which the chess piece is moved.

In operation S400, it is determined whether the final location to which the chess piece is moved is an effective location based on the rule of chess games.

If it is determined that the final location to which the chess piece is moved is an effective location, the final location is mapped into a coordinate location of the chess piece on the tablet PC in operation S500.

In particular, the final location can be mapped into a coordinate location of the chess piece on the tablet PC, according to the distance h between the projected image by projecting of the projector and the tablet PC, and the scaling factor α between the projected image and the image displayed on the tablet PC. For example, the final location can be mapped into a coordinate location of the chess piece on the tablet PC, according to the following mapping relationship between the coordinate (x′, y′, z′) of the projected image in 3D space and the coordinate (x, y) of the image displayed on the tablet PC: x′=αx, y′=αy, z′=h.

If it is determined in operation S400 that the location, to which the chess piece is moved, is not an effective location, the operation for the current chess games is terminated.

In operation S600, the chessboard displayed on the chessboard is updated based on the corresponding location of the chess piece on the tablet PC.

FIG. 8 is a diagram illustrating a scene using the device and method for operating 3D virtual chessboard according to exemplary embodiments of the present invention.

According to an exemplary embodiment of the present invention, a device and method for operating 3D virtual chessboard is proposed in conjunction with the tablet PC and projection technology, so that a user is convenient for operation greatly, the user is provided with an interactive manner for funny, and interactive effects between the user and machine are enhanced.

While the invention has been shown and described with reference to certain exemplary embodiments thereof, it will be understood by those skilled in the art that various changes in form and details may be made therein without departing from the spirit and scope of the invention as defined by claims.

What is claimed is:

1. A device for operating 3D virtual chessboard, the device is used for a tablet PC provided with at least two cameras and one micro 3D holograph projector, the at least two cameras are used to capture images of chess games, and the micro 3D holograph projector is used to map the chessboard displayed on the tablet PC into 3D space, wherein the device includes:
an image identifying module which identifies images captured by the at least two cameras;
a start action determining module which determines the start of an action for chess games based on the image identification result of the image identifying module, so as to determine which chess piece is moved;
an end action determining module which determines the end of the action for chess games based on the image identification result of the image identifying module, so as to determine the final location to which the chess piece is moved;
an effective location determining module which determines whether the final location to which the chess piece is moved is an effective location based on a rule of chess games;
a mapping module which maps the final location into a coordinate location of the chess piece on the tablet PC, if the effective location determining module determines that the final location to which the chess piece is moved is the effective location;
a chessboard updating module which updates the chessboard displayed on the tablet PC based on the coordinate location of the chess piece on the tablet PC.

2. The device of claim 1, wherein, the start action determining module counts the gestures identified by the image identifying module, and determines the start of the action of chess games, so as to determine which one chess piece is moved, if the counting number of the gestures identified in a predetermined time period is larger than or equal to a predetermined threshold.

3. The device of claim 1, wherein, if no gesture in images captured by the at least two cameras is identified by the image identifying module in a predetermined time period, the end action determining module determines the end of the current action for chess games, so as to determine the final location to which the chess piece is moved.

4. The device of claim 1, wherein, the mapping module maps the final location into a coordinate location of the chess piece on the tablet PC, based on the distance h between the projected image by projecting of the projector and the tablet PC and the scaling factor α between the projected image and the image displayed on the tablet PC.

5. The device of claim 4, wherein, the mapping module maps the final location into a coordinate location of the chess piece on the tablet PC, according to the following mapping relationship between the coordinate (x′, y′, z′) of the projected image in 3D space and the coordinate (x, y) of the image displayed on the tablet PC: x′=αx, y′=αy, z′=h.

6. The device of claim 5, wherein, h and α are constants, which are obtained upon initializing the 3D virtual chessboard after setting the projector.

7. A method for operating 3D virtual chessboard, the method is applied to a tablet PC provided with at least two cameras and one micro 3D holograph projector, the at least two cameras are used to capture images of chess games, and the micro 3D holograph projector is used to map the chessboard displayed on the tablet PC into 3D space, wherein the method includes the following steps:
identifying images captured by the at least two cameras;
determining the start of an action for chess games based on the image identification result, so as to determine which chess piece is moved;
determining the end of the action for chess games based on the image identification result, so as to determine the final location to which the chess piece is moved;
determining the final location to which the chess piece is moved is an effective location based on the rule of chess games;
mapping the final location into a coordinate location of the chess piece on the tablet PC, if it is determined that the final location to which the chess piece is moved is the effective location;
updating the chessboard displayed on the tablet PC based on the coordinate location of the chess piece on the tablet PC.

8. The method of claim 7, wherein, the step of determining the start of an action for chess games based on the image identification result, so as to determine which chess piece is moved, includes:
counting the gestures identified by the image identification, and determining the start of the action of chess games, so as to determine which one chess piece is moved, if the counting number of the gestures identified in a predetermined time period is larger than or equal to a predetermined threshold.

9. The method of claim 7, wherein, the step of determining the end of the action for chess games based on the image identification result, so as to determine the final location to which the chess piece is moved, includes:
if no gesture in images captured by the at least two cameras is identified in a predetermined time period, determining the end of the current action for chess games, so as to determine the final location to which the chess piece is moved.

10. The method of claim 7, wherein, the step of mapping the final location into a coordinate location of the chess piece on the tablet PC includes:
mapping the final location into a coordinate location of the chess piece on the tablet PC, based on the distance h between the projected image by projecting of the projector and the tablet PC and the scaling factor α between the projected image and the image displayed on the tablet PC.

11. The method of claim 10, wherein, mapping the final location into a coordinate location of the chess piece on the tablet PC, according to the following mapping relationship between the coordinate (x′, y′, z′) of the projected image in 3D space and the coordinate (x, y) of the image displayed on the tablet PC: x′=αx, y′=αy, z′=h.

12. The method of claim 11, wherein, h and α are constants, which are obtained upon initializing the 3D virtual chessboard after setting the projector.
